(19) United States
(12) Patent Application Publication
(10) Pub. No.: US 2026/0023796 A1
(43) Pub. Date: Jan. 22, 2026

(54) RECOMMENDATION SYSTEM, RECOMMENDATION METHOD, AND COMPUTER-READABLE STORAGE MEDIUM STORING PROGRAM

(71) Applicant: FIXER Inc., Tokyo (JP)

(72) Inventor: Seiichi MATSUOKA, Tokyo (JP)

(21) Appl. No.: 19/257,467

(22) Filed: Jul. 2, 2025

(30) Foreign Application Priority Data
Jul. 16, 2024 (JP) 2024-113034

(51) Int. Cl. G06F 16/9535

(52) U.S. Cl. CPC G06F 16/9535

(57) ABSTRACT

In a recommendation system, a task executing section accepts a request including text data from a user, and causes a first language model which is one language model specified by the user from a plurality of language models to generate a first response to the request. An evaluation information acquiring section acquires, from a predetermined database, evaluation information about each of the plurality of language models. A recommendation information generating section causes a second language model whose execution environment is different from the first language model to select a recommended language model for generating a response to the request from the plurality of language models on the basis of the request, the first response, and the evaluation information. Furthermore, the recommendation information generating section causes the second language model to generate recommendation information including a message to present the recommended language model to the user.

### CROSS-REFERENCE TO RELATED APPLICATIONS

The present application claims priority to Japanese Patent Applications number 2024-113034, filed on Jul. 16, 2024, contents of which are incorporated herein by reference in their entirety.

### BACKGROUND OF THE INVENTION

The present disclosure relates to a recommendation system, a recommendation method, and a program.

Generative AI (Artificial Intelligence) services using large language models (LLMs (Large Language Models)) that generate responses to various requests from users are becoming widespread. Users use any service from a plurality of generative AI services. In addition, users select any LLM from a plurality of LLMs having different features in a generative AI service, and transmits a request to the LLM. In connection with this, a plurality of proposals for selectively using a plurality of trained models have been disclosed.

For example, in the technology described in Japanese Patent Application Publication No. 2023-114460, learning models that have learned lifelogs of individual experts, and predict responses from the respective individual experts are stored as digital clones, and a plurality of digital clones are evaluated by inputting question data to corresponding digital clones, and causing the digital clones to output predicted responses.

In addition, in the technology described in Japanese Patent Application Publication No. 2023-082970, one of a plurality of learning models is selected according to the content of an acquired question item or a demand from a questioner, and question data is input to the selected learning model.

The system described in Japanese Patent Application Publication No. H07-104786 includes a speech circuit that automatically generates speech according to speech content of an operator, and includes a circuit that stores and selects different statistical language models according to a plurality of scenes, and a voice recognition circuit that performs voice recognition on the content of speech after the speech.

However, the technologies mentioned above can be used for particular limited learning models. On the other hand, the development of technologies to select an LLM that can appropriately respond to user requests has been expected.

### BRIEF SUMMARY OF THE INVENTION

The present disclosure has been made in view of the problems described, and an object thereof is to provide a recommendation system and the like that suitably propose an LLM that can appropriately respond to user requests.

A recommendation system according to the present disclosure has a task executing section, an evaluation information acquiring section, and a recommendation information generating section. The task executing section accepts a request including text data from a user, and causes a first language model which is one language model specified by the user from a plurality of language models to generate a first response to the request. The evaluation information acquiring section acquires, from a predetermined database, evaluation information about each of the plurality of language models. The recommendation information generating section causes a second language model whose execution environment is different from the first language model to select a recommended language model for generating a response to the request from the plurality of language models on the basis of the request, the first response, and the evaluation information. Furthermore, the recommendation information generating section causes the second language model to generate recommendation information including a message to present the recommended language model to the user.

In a recommendation method according to the present disclosure, a computer executes the following processes. The computer accepts a request including text data from a user, and causes a first language model which is one language model specified by the user from a plurality of language models to generate a first response to the request. The computer acquires, from a predetermined database, evaluation information about each of the plurality of language models. The computer causes a second language model whose execution environment is different from the first language model to select a recommended language model for generating a response to the request from the plurality of language models on the basis of the request, the first response, and the evaluation information. The computer causes the second language model to generate recommendation information including a message to present the recommended language model to the user.

A computer-readable storage medium that non-transitorily stores a program according to the present disclosure stores a program for causing a computer to execute the following recommendation method. By executing the program, the computer accepts a request including text data from a user, causes a first language model which is one language model specified by the user from a plurality of language models to generate a first response to the request, acquires, from a predetermined database, evaluation information about each of the plurality of language models, causes a second language model whose execution environment is different from the first language model to select a recommended language model for generating a response to the request from the plurality of language models on the basis of the request, the first response, and the evaluation information, and causes the second language model to generate recommendation information including a message to present the recommended language model to the user.

### BRIEF DESCRIPTION OF THE DRAWINGS

FIG. 1 is a block diagram of a response system according to a first embodiment.

FIG. 2 is a block diagram of a recommendation system according to the first embodiment.

FIG. 3 is a block diagram illustrating the hardware configuration of a computer.

FIG. 4 is a flowchart of a recommendation method according to the first embodiment.

FIG. 5 is a first figure depicting evaluation information.

FIG. 6 is a figure depicting the flow of information in the recommendation system according to the first embodiment.

FIG. 7 is a figure depicting a variation of a message generated by a recommendation information generating section.

FIG. 8 is a block diagram of the recommendation system according to a second embodiment.

FIG. 9 is a flowchart of the recommendation method according to the second embodiment.

FIG. 10 is a figure depicting the flow of the information in the recommendation system according to the second embodiment.

FIG. 11 is a block diagram of the recommendation system according to a third embodiment.

FIG. 12 is a flowchart of the recommendation method according to the third embodiment.

FIG. 13 is a second figure depicting the evaluation information.

FIG. 14 is a figure depicting the flow of the information in the recommendation system according to the third embodiment.

FIG. 15 is a flowchart of the recommendation method according to a fourth embodiment.

FIG. 16 is a figure depicting a variation of the message generated by the recommendation information generating section.

FIG. 17 is a block diagram depicting a variation of the response system.

### DETAILED DESCRIPTION OF THE INVENTION

Hereinbelow, the present invention is explained through embodiments of the invention; however, the invention according to claims is not intended to be limited to the following embodiments. In addition, it is not always the case that all constituent elements explained in the embodiments are essential as solutions to the problems. For clarification of the explanation, omissions and simplifications are made as appropriate in the following description and figures. Note that identical elements in respective figures are given identical reference signs, and overlapping explanations are omitted as necessary.

### First Embodiment

### Response System 10

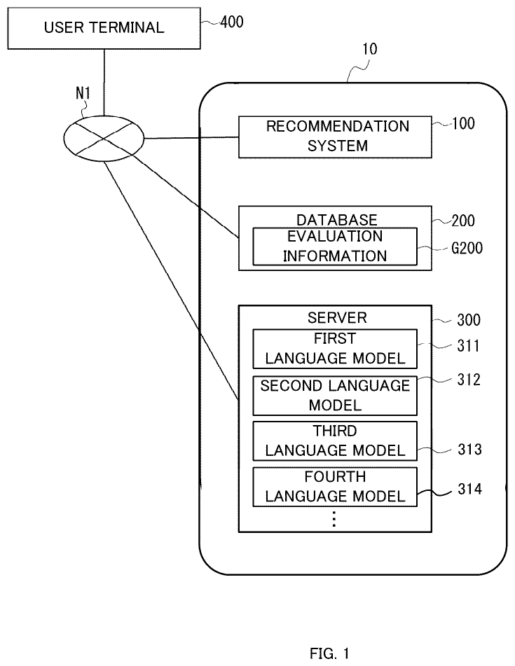

A response system 10 is explained with reference to FIG. 1. FIG. 1 is a block diagram of the response system 10 according to the first embodiment. The response system 10 accepts a request from a user, selects a recommended language model for generating a response to the accepted request from a plurality of language models, and presents recommendation information about the selected recommended language model to the user. The response system 10 is communicatively connected with a user terminal 400 via a network N1. As primary constituent elements, the response system 10 has a recommendation system 100, a database 200, and a server 300.

The recommendation system 100 is a computer or a server having communication functions. The recommendation system 100 is communicatively connected with the user terminal 400 via the network N1. In addition, the recommendation system 100 is communicatively connected with the database 200 and the server 300 via the network N1. Thereby, the recommendation system 100 selects the recommended language model mentioned above in cooperation with the database 200 and the server 300.

In addition to a request, the recommendation system 100 accepts the specification of a language model for generating a response to the request from the user terminal 400. In this case, the recommendation system 100 causes the specified language model to generate the response to the request. Note that details of the recommendation system 100 are mentioned later.

The database 200 is a computer, a server, or a storage apparatus including at least a non-volatile memory. The database 200 is communicatively connected with the recommendation system 100 via the network N1. The database 200 has stored thereon at least evaluation information G200. The evaluation information G200 is information evaluating each of a plurality of language models that can be used by the recommendation system 100. The evaluation information G200 is used in a case where the recommendation system 100 selects the recommended language model. According to a demand from the recommendation system 100, the database 200 supplies at least part of the evaluation information G200 to the recommendation system 100.

The server 300 is a server communicatively connected with the recommendation system 100. The server 300 includes a plurality of different language models. Specifically, for example, the server 300 has a first language model 311, a second language model 312, a third language model 313, a fourth language model 314, and the like. These language models are LLMs, and are configured to be available for use by the recommendation system 100. That is, the language models that the server 300 has accept access from the recommendation system 100, generate responses to any request, and supply the generated responses to the recommendation system 100.

The language models that the server 300 has may have all functions as generative AI at the server 300. In addition, the language models that the server 300 has may have APIs (Application Programming Interfaces) for causing predetermined LLMs to function at the server 300. In this case, the language models may be configured to function as generative AI in cooperation with an external apparatus.

Note that, for example, the plurality of different language models that the server 300 has are language models provided from a plurality of different generative AI service providers. In addition, the plurality of different language models may be language models provided by the same generative AI service, and mutually different versions of a language model. In addition, these language models may have functions called RAG (Retrieval-Augmented Generation). RAG is a mechanism that searches for external information in text generation by an LLM, and uses search results for response generation. RAG is also called “retrieval-augmented generation” or “acquisition-augmented generation.” By being capable of RAG, LLMs can generate information which is highly relevant to requests.

The user terminal 400 is a computer, a smartphone, a tablet terminal, or the like used by a user. As an example, the user terminal 400 has installed thereon an application for accessing the response system 10. The user who uses the user terminal 400 transmits a request to the response system 10 via the application. The user who uses the user terminal 400 receives a response to the request from the response system 10 via the application. Note that whereas there is one user terminal 400 in FIG. 1, the response system 10 can be communicatively connected with a plurality of user terminals 400. In addition, the application for accessing the response system 10 may not be installed on the user terminal 400, but the user terminal 400 may access the response system 10 via a general-purpose browser.

### Recommendation System 100

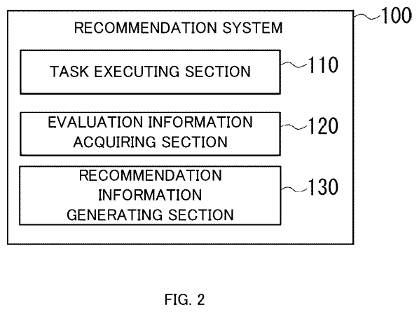

FIG. 2 is a block diagram of the recommendation system according to the first embodiment. As primary constituent elements, the recommendation system 100 has a task executing section 110, an evaluation information acquiring section 120, and a recommendation information generating section 130.

The task executing section 110 accepts a request including text data from a user, and causes the first language model 311, which is one language model specified by the user from the plurality of language models, to generate a first response to the request. That is, the task executing section 110 inputs the request accepted from the user to the first language model 311 specified by the user in cooperation with the server 300, and causes the first language model 311 to generate the first response. In this case, the request accepted from the user may be called a prompt. The “prompt” in the present disclosure is an instruction sentence that is to be input to a language model, and is for obtaining a response. The task executing section 110 may present, to the user terminal 400, the response to the request accepted from the user.

The evaluation information acquiring section 120 acquires, from a predetermined database, evaluation information about each of the plurality of language models. In this case, the predetermined database is the database 200. The evaluation information G200 stored on the database 200 includes evaluations related to the first language model 311. The evaluations related to the first language model 311 include: actual prompts which are information including at least part of prompts input to the first language model 311 in the past; and information about evaluations of actual responses which are responses generated by the first language model 311 to the actual prompts. Thereby, the recommendation system 100 can reference how the actual responses to the actual prompts accepted by the first language model 311 are evaluated. In addition, the recommendation system 100 can reference similar information about evaluations also regarding language models different from the first language model 311.

The recommendation information generating section 130 selects a recommended language model for generating a response to the request from the plurality of language models on the basis of the request, the first response, and the evaluation information G200. In addition, the recommendation information generating section 130 causes the second language model 312 whose execution environment is different from the first language model 311 to generate recommendation information including a message to present the recommended language model to the user.

More specifically, for example, the recommendation information generating section 130 inputs, to the second language model 312, the request accepted from the user and the first response generated by the first language model 311. The second language model 312 is configured to select a recommended language model with reference to the input request and first response, and the evaluation information G200, and generate the message to present the selected recommended language model to the user.

Note that a “language model whose execution environment is different” in the present disclosure includes a case where the type of a language model itself is different. In addition, a “language model whose execution environment is different” includes a case where the type of a language model is the same, and its version is different. In addition, a “language model whose execution environment is different” includes a case where the type and version of a language model are the same, and its conditions specified in a case where a response is generated are different. For example, the conditions specified in a case where a response is generated are the content of a prompt instruction. For example, the content of a prompt instruction in this case can include the policy of an instruction such as “Please summarize,” “Please propose ideas,” and “Please evaluate text.” Such a policy of an instruction can be also called a “request type.”

As mentioned above, the recommendation information generating section 130 causes the second language model 312 to generate recommendation information. In a case where the recommended language model included in the recommendation information is a language model different from the first language model 311, the recommendation system 100 presents, to the user, the recommended language model that has the potential to generate a more appropriate response to the user request than the first language model 311. In this case, the user having received the recommendation information can specify the recommended language model, and transmits the request to the recommendation system 100. Thereby, the recommendation system 100 can provide an appropriate response to the user.

Note that, in a case where the recommended language model included in the recommendation information is the first language model 311, the recommendation system 100 may present, to the user, a message that the first language model 311 has the potential to generate an appropriate response to the user request.

In the recommendation system 100 mentioned above, language models that are set as ones that can be specified by the user and recommended language models that are set as ones that can be selected by the recommendation information generating section 130 may be different. In other words, in the recommendation system 100, the types of language models that are set as ones that can be specified by the user and the types of recommended language models that are set as ones that can be selected by the recommendation information generating section 130 may be different. There may be language models that are set as ones that can be additionally used by the user at a cost or for free depending on the type of service the user receives. In this case, for example, it becomes possible for the user to use a recommended language model that cannot be specified by the user, as an optional service. That is, the task executing section 110 accepts the specification of the first language model 311 from the plurality of language models that can be specified by the user, and the recommendation information generating section 130 selects the recommended language model from the plurality of language models extending beyond a scope of language models that can be specified by the user. For example, the scope of language models that can be specified by the user is stored on a memory that the recommendation system 100 has. The scope of language models that can be specified by the user may be a scope corresponding to a used service type stored on the memory in association with the user.

With such a configuration, the recommendation system 100 can select the recommended language model which is an option for the user. In addition, the user who uses the recommendation system 100 can select a recommended language model which is additionally selectable as necessary in an actual use scene.

Note that the recommended language model may be set as a fee-based option. In this case, the recommendation system 100 may prompt the user to select whether to or not to use the recommended language model as a fee-based option service.

In generative AI services using LLMs, there is a demand from users to obtain more appropriate responses to requests the users desire to ask. Using an appropriate LLM according to a request enhances the likelihood of the users obtaining responses of higher generation quality. Here, for example, the generation quality can include elements such as the accuracy, relevance, consistency, and customizability of responses. Accuracy is an element representing whether or not a response is based on facts. Relevance is an element representing whether or not a response is directly related to a question from a user. Consistency is an element representing whether or not a response is logical, and has consistent content. Customizability is an element representing whether or not a response aligns with the individual needs or background of a user.

Suppose, for example, that a user has transmitted a request, “What's the weather in Tokyo today?,” and the first language model 311 specified by the user does not have an RAG function. In this case, the first language model 311 generates a response, “I cannot check the today's weather in Tokyo.” Suppose, on the other hand, that the recommended language model has an RAG function. In this case, for example, the recommended language model searches the weather in Tokyo by Internet search, and generates a response. The recommendation information generating section 130 presents, to the user, the recommended language model having the RAG function. Thereby, the recommendation system 100 can present, to the user, a generative AI service of higher generation quality. In addition, in a case where the provider of the response system 10 provides users with language models of higher generation quality as options, it can be expected to expand upselling opportunities.

### Hardware Configuration Example

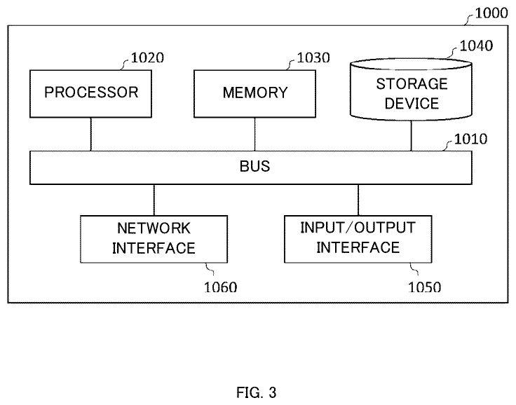

FIG. 3 is a block diagram illustrating the hardware configuration of a computer. The recommendation system 100 mentioned above can have a configuration depicted in FIG. 3. A computer 1000 has a bus 1010, a processor 1020, a memory 1030, a storage device 1040, an input/output interface 1050, and a network interface 1060.

The bus 1010 is a data transfer path for allowing the processor 1020, the memory 1030, the storage device 1040, the input/output interface 1050, and the network interface 1060 to transmit and receive data mutually. It should be noted that the method of interconnecting the processor 1020 and the like is not limited to bus connection.

The processor 1020 is a circuit including an arithmetic operation apparatus such as a CPU (Central Processing Unit) or a GPU (Graphics Processing Unit).

The memory 1030 is a main storage apparatus realized using an RAM (Random Access Memory) or the like.

The storage device 1040 is an auxiliary storage apparatus such as an HDD (Hard Disk Drive), an SSD (Solid State Drive), a flash memory, or a ROM (Read Only Memory). The storage device 1040 stores a program for realizing functions of the present disclosure.

The processor 1020 reads out the program onto the memory 1030, and executes the program. Thereby, the processor 1020 executes functions corresponding to the program. In other words, the program stored on the memory 1030 causes the computer 1000 to execute the functions of the present disclosure.

The input/output interface 1050 connects the computer 1000 and a predetermined input/output device. For example, the input/output device is an input apparatus such as a keyboard, an output apparatus such as a display, or an input/output apparatus in which a touch panel is superimposed on a display.

The network interface 1060 is an interface for connecting the computer 1000 to a predetermined communication network.

### Recommendation Method

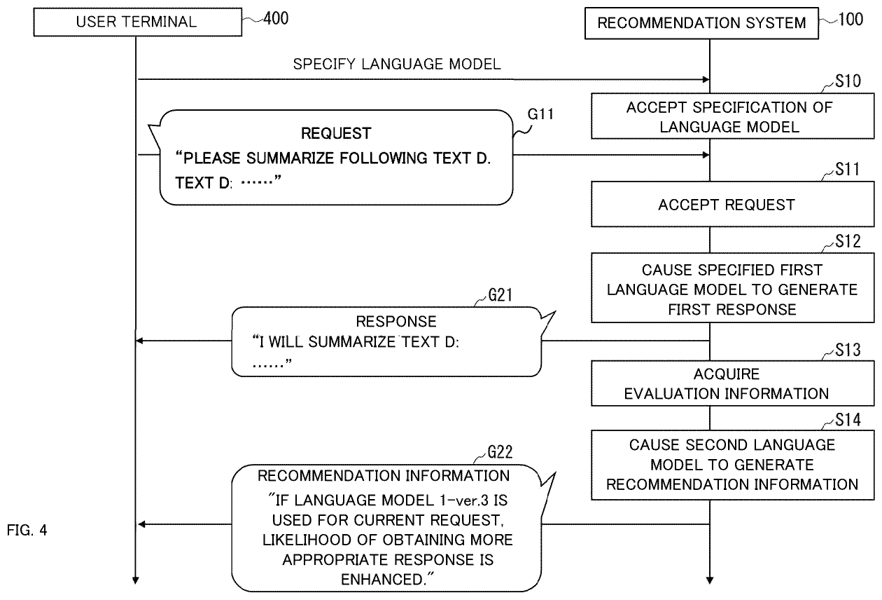

Next, a process executed by the recommendation system 100 is explained with reference to FIG. 4. FIG. 4 is a sequence diagram depicting a recommendation method according to the first embodiment. Note that the sequence diagram in FIG. 4 includes the exchange of information between the user terminal 400 and the recommendation system 100, and the recommendation method executed by the recommendation system 100. In the recommendation method according to the present disclosure, the following processes from Step S10 to Step S14 are executed by the recommendation system 100.

At Step S10, the recommendation system 100 accepts the specification of a language model from the user terminal 400.

At Step S11, the task executing section 110 accepts a request including text data from the user terminal 400. In the example depicted in FIG. 4, the user terminal 400 transmits, to the recommendation system 100, a message, “Please summarize the following text D. The text D: ⋅⋅⋅⋅⋅,” as a request G11.

At Step S12, the task executing section 110 causes the first language model 311, which is one language model specified by the user from the plurality of language models, to generate the first response to the received request. In this case, the task executing section 110 causes the first language model 311 to generate the response in cooperation with the server 300. That is, the task executing section 110 supplies, to the specified first language model 311, the request G11 accepted from the user terminal 400. The task executing section 110 has received, from the first language model 311, a message, “I will summarize the text D: ⋅⋅⋅⋅⋅,” as a first response G21. Upon receiving the first response G21, the task executing section 110 transmits the received first response G21 to the user terminal 400.

At Step S13, the evaluation information acquiring section 120 acquires, from a predetermined database, that is, from the database 200, the evaluation information G200 about each of the plurality of language models. The evaluation information acquiring section 120 supplies the acquired evaluation information G200 to the recommendation information generating section 130.

At Step S14, the recommendation information generating section 130 causes the second language model 312 whose execution environment is different from the first language model 311 to generate recommendation information G22 in cooperation with the server 300. In this case, the second language model 312 selects a recommended language model for generating a response to the request from the plurality of language models on the basis of the request G11, the first response G21, and the evaluation information G200. Furthermore, the second language model 312 generates the recommendation information G22 including the message to present the recommended language model to the user.

A process executed by the recommendation system 100 has been explained thus far. In the process mentioned above, the recommended language model may match the first language model 311 in the recommendation system 100, in some cases. In a case where the recommended language model matches the first language model 311, the recommendation information generating section 130 may refrain from transmitting the generated recommendation information to the user terminal 400. By such a process, the recommendation system 100 can refrain from presenting information which is redundant to the user. Note that the language model specified by the user at Step S10 may be preset.

### Evaluation Information G200

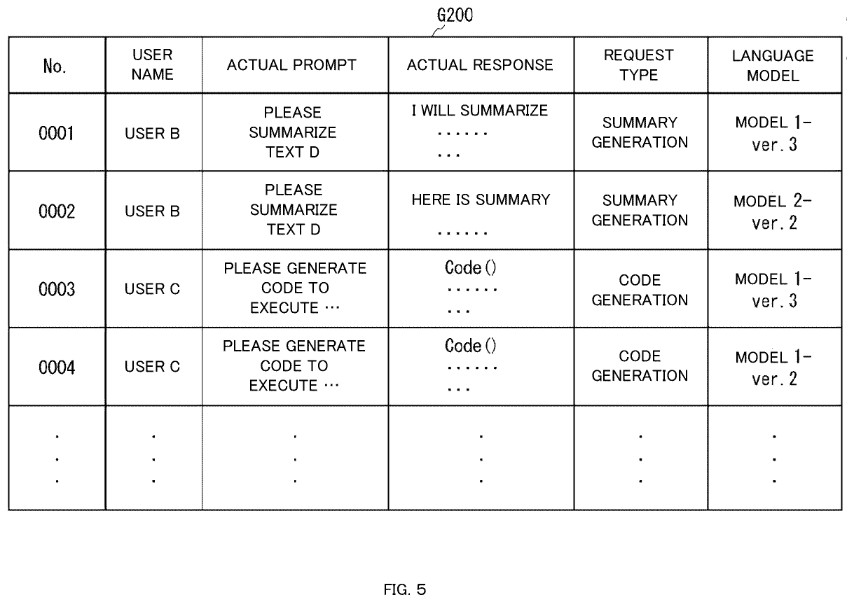

Next, the evaluation information G200 is explained with reference to FIG. 5. FIG. 5 is a first figure depicting the evaluation information G200. The evaluation information G200 includes user names, actual prompts, actual responses, request types, and language models.

The user names are designations for identifying users operating the user terminal 400. The user names may be predetermined IDs (Identifiers) or may be the full names of or designations of the users.

The actual prompts are input information including at least part of requests input by the users. The actual responses are responses generated by the language models to the requests. The request types broadly classify the types of responses that are desired to be generated by the language models in response to the actual prompts. The request types can also be said to be the content of instructions provided by the actual prompts.

For example, the request types are summary generation, code generation, translation generation, brainstorming assistance, information search result presentation, example sentence presentation, and the like. Any definitions can be set for the request types.

The language models are information that enable the identification of language models. The language models may be unique identifiers or may be the designations or the like of the language models.

Specifically, for example, the evaluation information G200 includes information like the one below. The first information has content that an actual response, “I will summarize ⋅ ⋅ ⋅ ” has been obtained in a case where a user B has transmitted a request, “Please summarize the text D,” to a language model “model 1-ver.3.” The second information has content that an actual response, “Here is the summary ⋅ ⋅ ⋅ ” has been obtained in a case where the user B has transmitted a request, “Please summarize the text D,” to a language model “model 2-ver.2.”

The third information includes content that a code generated by the language model “model 1-ver.3” has been obtained as an actual response in a case where a user C has transmitted a request, “Please generate a code to execute ⋅ ⋅ ⋅ ,” to the language model.

The fourth information includes content that a code generated by a language model “model 1-ver.2” has been obtained as an actual response in a case where the user C has transmitted a request, “Please generate a code to execute ⋅ ⋅ ⋅ ,” to the language model.

Since the information mentioned above is included, the recommendation information generating section 130 causes the second language model to generate recommendation information including a recommended language model. Note that the evaluation information G200 may include some of the items mentioned above. For example, the evaluation information G200 may not include user names. In addition, in addition to the items mentioned above, for example, the evaluation information G200 may include information representing whether or not language models have an RAG function.

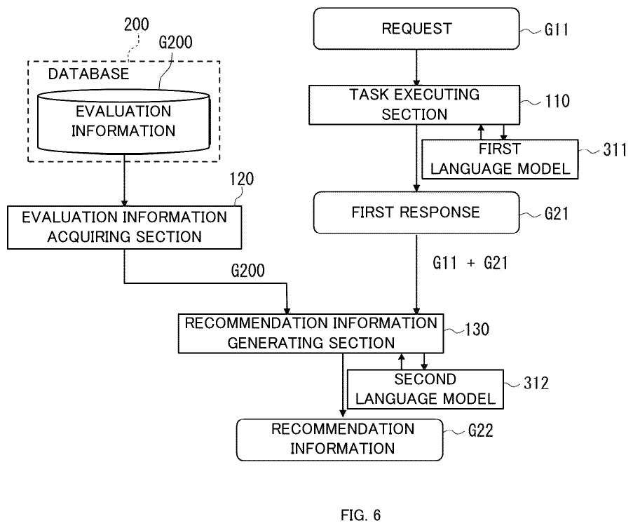

Next, the flow of information processed by the recommendation system 100 is explained with reference to FIG. 6. FIG. 6 is a figure depicting the flow of the information in the recommendation system 100 according to the first embodiment.

Upon receiving the request G11 from the user terminal 400, the task executing section 110 causes the first language model 311 to generate the first response G21. The task executing section 110 supplies the request G11 and the first response G21 to the recommendation information generating section 130.

The evaluation information acquiring section 120 acquires the evaluation information G200 from the database 200. The evaluation information acquiring section 120 supplies the acquired evaluation information G200 to the recommendation information generating section 130.

Upon receiving the request G11, the first response G21, and the evaluation information G200, the recommendation information generating section 130 supplies these received pieces of information to the second language model 312, and causes the second language model 312 to generate the recommendation information G22.

As mentioned above, the recommendation system 100 causes the second language model 312 whose execution environment is different from the first language model 311 to generate the recommendation information G22. The second language model 312 generates the recommendation information G22 with reference to the evaluation information G200.

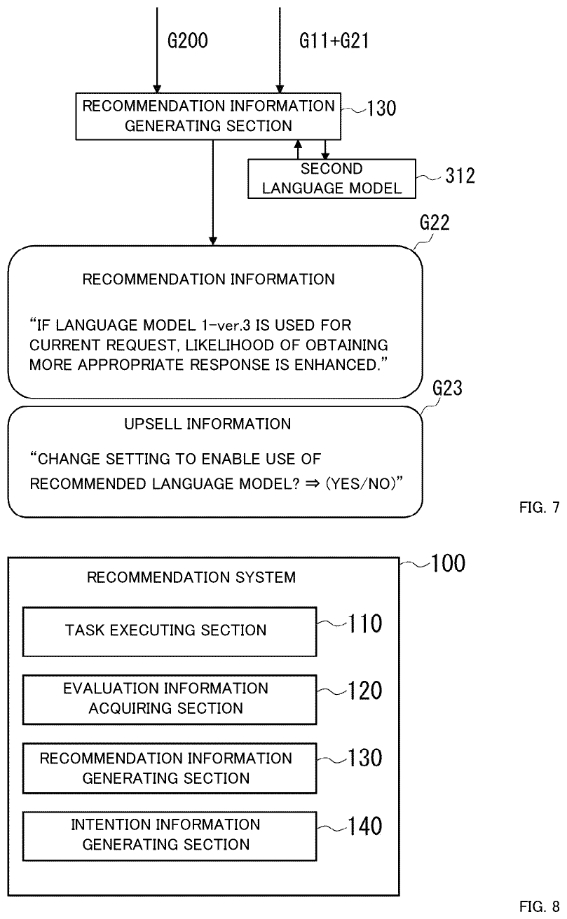

Next, a variation of the message generated by the recommendation information generating section 130 is explained with reference to FIG. 7. FIG. 7 is a figure depicting a variation of the message generated by the recommendation information generating section 130.

FIG. 7 depicts information output by the recommendation information generating section 130 having received the request G11, the first response G21, and the evaluation information G200. In addition to the recommendation information G22, the recommendation information generating section 130 generates upsell information G23. The upsell information G23 can include a message prompting the user to use the recommended language model. The upsell information G23 can alternatively include a message prompting the user to select whether to or not to use the recommended language model.

In FIG. 7, the upsell information G23 includes a message prompting to select either “Yes” or “No,” along with a message, “Change the setting to enable the use of the recommended language model?.” In this case, the recommendation system 100 provides an interface on the user terminal 400 for accepting operations to enable the use of the recommended language model. Thereby, the recommendation system 100 can provide an opportunity to enable the use of the recommended language model smoothly to the user. In a case where the recommended language model is a fee-based service as an option, the recommendation information generating section 130 may generate, as the upsell information G23, a message including guidance about the fee.

Note that, in a case where an operation to select the use of the recommended language model is accepted from the user terminal 400, the task executing section 110 may cause the recommended language model to generate a response to the request G11. Thereby, the recommendation system 100 can provide a desired response while keeping the number of steps of user operations small.

The response system 10 and the recommendation system 100 have been explained thus far. Each constituent element that the recommendation system 100 has may be realized by dedicated hardware. In addition, some or all of constituent elements may be realized by a general-purpose or dedicated circuit (circuitry), a processor, and the like or a combination of these. These may be configured using a single chip, or may be configured using a plurality of chips connected via a bus. Some or all of constituent elements may be realized by a combination of a circuit or the like mentioned above and a program. In addition, a CPU (Central Processing Unit), a GPU (Graphics Processing Unit), an FPGA (field-programmable gate array), and the like can be used as the processor. In addition, at least some of the functions of the present embodiment may be provided in formats such as IaaS (Infrastructure as a Service), PaaS (Platform as a Service), or Saas (Software as a Service).

In addition, in addition to text data, the request G11 that the recommendation system 100 receives from the user terminal 400 may be image data, sound data, or data including other information. For example, the data including other information is signals generated by a predetermined sensor. In this case, the first language model 311 and the second language model 312 are language models supporting multimodality. For example, the language models supporting multimodality can be called MMLLMs (Multi Modal Large Language Models) or multimodal models. The language models supporting multimodality may generate responses as text data or may generate responses including image data or sound data. Also in this case, the evaluation information G200 mentioned above may include information representing whether or not each of the language models supports multimodality. The evaluation information G200 may include information representing which type of data in multimodality each of the language models can handle. With such a configuration, the recommendation system 100 can suitably propose an LLM that can appropriately respond to a request corresponding to multimodality. Note that, in the following explanation also, all the language models may be ones supporting multimodality.

Whereas the response system 10 mentioned above has a configuration in which each of the recommendation system 100, the database 200, and the server 300 is communicatively connected to the network N1, the configuration of the response system 10 is not limited to the one mentioned above. In the response system 10, at least part of the recommendation system 100, the database 200, and the server 300 may be an integrated apparatus. In addition, for example, in the response system 10, part of the recommendation system 100 may be configured being integrated with the database 200 or the server 300. As mentioned above, the present embodiment can provide the recommendation system, the recommendation method, and the program that suitably propose an LLM that can appropriately respond to user requests.

### Second Embodiment

Next, a second embodiment is explained. The recommendation system 100 according to the second embodiment is different from the recommendation system 100 mentioned above in that the recommendation system 100 according to the second embodiment has an intention information generating section 140.

FIG. 8 is a block diagram of the recommendation system 100 according to the second embodiment. As primary constituent elements, the recommendation system 100 has the task executing section 110, the evaluation information acquiring section 120, the recommendation information generating section 130, and the intention information generating section 140.

The intention information generating section 140 causes the third language model 313 whose execution environment is different from the first language model 311 to generate intention information for being input to the first language model 311 on the basis of the request G11 for the purpose of supplementing the request. On text data which is the request, for example, the third language model 313 performs a process such as cleaning, tokenization, sentiment analysis, or semantic understanding. The third language model 313 may search for a language extracted from the text data which is the request, in a case where the third language model 313 has an RAG function.

The task executing section 110 in the present embodiment inputs at least part of the intention information to the first language model 311, and causes the first language model 311 to generate the first response G21. Thereby, the recommendation system 100 can enhance the quality of the response generated by the task executing section 110.

For example, the intention information includes the request type of the request received from the user terminal 400. That is, the intention information generating section 140 generates the intention information including information about the type of the request on the basis of the context of the text data. The information about the type of the request is information including at least the request type.

The intention information may include information acquired by the third language model 313 by searching for information related to a language included in the request received from the user terminal 400. That is, the intention information generating section 140 may include a search engine that searches for information in a predetermined network in cooperation with the third language model 313, and cause the third language model 313 and the search engine to generate the intention information. For example, the search engine has an RAG (Retrieval-Augmented Generation) function.

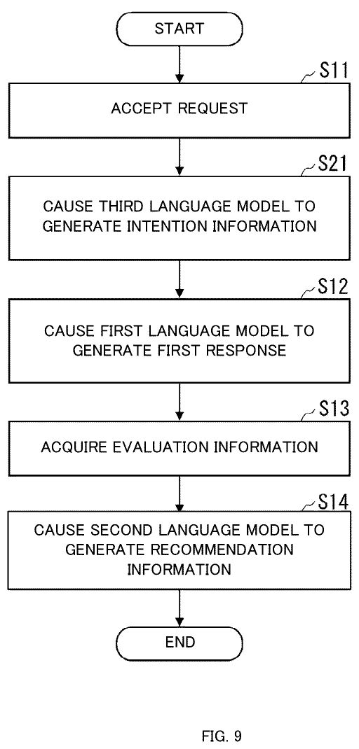

FIG. 9 is a flowchart of the recommendation method according to the second embodiment. The flowchart depicted in FIG. 9 is different from the flowchart of the recommendation system 100 included in the sequence diagram depicted in FIG. 4 in that the flowchart depicted in FIG. 9 has Step S21 between Step S11 and Step S12.

At Step S11, the task executing section 110 accepts the request G11 including text data from the user terminal 400. The task executing section 110 supplies the accepted request G11 to the intention information generating section 140.

At Step S21, the intention information generating section 140 causes the third language model 313 to generate the intention information on the basis of the request G11 received from the task executing section 110. The intention information generating section 140 supplies, to the task executing section 110, the intention information that the third language model 313 has been caused to generate.

At Step S12, the task executing section 110 supplies the request G11 and the intention information to the first language model 311, and causes the first language model 311 to generate the first response G21.

At Step S13, the evaluation information acquiring section 120 acquires, from the database 200, the evaluation information G200 about each of the plurality of language models. The evaluation information acquiring section 120 supplies the acquired evaluation information G200 to the recommendation information generating section 130.

At Step S14, the recommendation information generating section 130 causes the second language model 312 to generate the recommendation information G22 in cooperation with the server 300. The recommendation information generating section 130 in the present embodiment selects a recommended language model for generating a response to the request from the plurality of language models on the basis of the request G11, the intention information, the first response G21, and the evaluation information G200. Furthermore, the second language model 312 generates the recommendation information G22 including the message to present the recommended language model to the user.

By the process mentioned above, the recommendation system 100 in the present embodiment generates the first response G21 using the intention information generated from the request G11. Thereby, the recommendation system 100 can reduce the deterioration of the generation quality of the first response G21. In addition, the recommendation system 100 generates the recommendation information G22 using the intention information. Thereby, the recommendation system 100 can reduce the deterioration of the generation quality of the recommendation information.

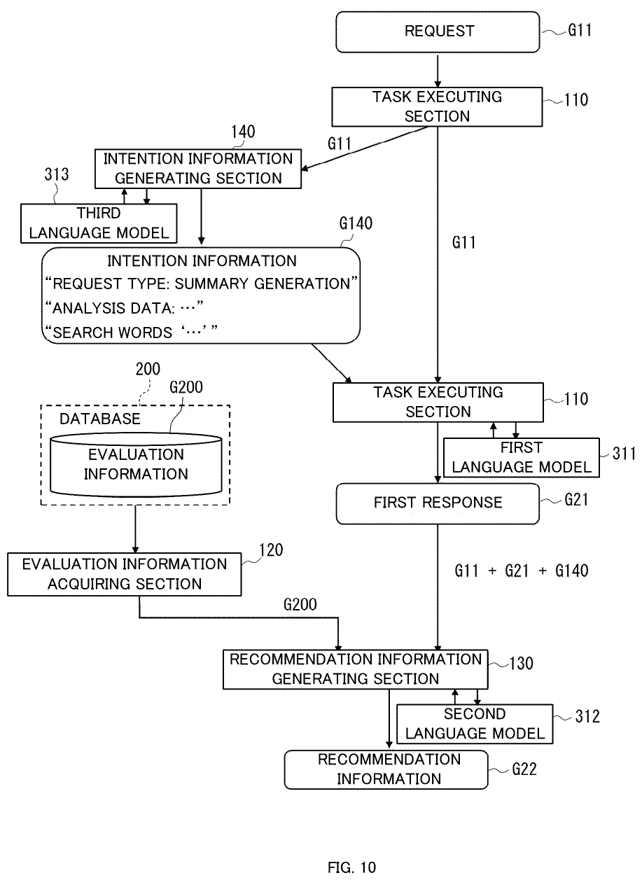

Next, the flow of the information processed by the recommendation system 100 according to the second embodiment is explained with reference to FIG. 10. FIG. 10 is a figure depicting the flow of the information in the recommendation system 100 according to the second embodiment.

Upon receiving the request G11 from the user terminal 400, the task executing section 110 supplies the received request G11 to the intention information generating section 140. The intention information generating section 140 supplies the request G11 to the third language model 313, and causes the third language model 313 to generate intention information G140. For example, the intention information includes a request type, analysis data, search words, and the like. The intention information generating section 140 supplies, to the task executing section 110, the intention information G140 generated by the third language model 313.

The request type depicted in FIG. 10 is “summary generation.” The request type of the intention information G140 is information with the same meaning as the request type of the evaluation information G200. For example, the analysis data can include information about tokenized words, information about the language type such as Japanese or English, sentiment analysis of text, and the like. For example, the search words are words extracted from the request G11, and words determined by the third language model 313 as requiring a search. In addition, the search words can include search results.

The task executing section 110 supplies the request G11 and the intention information G140 to the first language model 311, and causes the first language model 311 to generate the first response G21. Upon receiving the first response G21 from the first language model 311, the task executing section 110 supplies the received first response G21, request G11 and intention information G140 to the recommendation information generating section 130.

The recommendation information generating section 130 receives the evaluation information G200 from the evaluation information acquiring section 120. In addition, the recommendation information generating section 130 receives the request G11, the first response G21, and the intention information G140 from the task executing section 110. The recommendation information generating section 130 supplies these received pieces of information to the second language model 312, and causes the second language model 312 to generate the recommendation information G22.

The second embodiment has been explained thus far. With the configuration mentioned above, the recommendation system 100 generates the first response G21 to the user request G11 while reducing the deterioration of the generation quality. In addition, the recommendation system 100 presents, to the user, the recommended language model which is another language model that has the potential to provide generation quality higher than the first language model 311. Therefore, the present embodiment can provide the recommendation system, the recommendation method, and the program that suitably propose an LLM that can appropriately respond to user requests.

### Third Embodiment

Next, a third embodiment is explained. The third embodiment is different from the recommendation system 100 mentioned above in that the recommendation system 100 has an evaluating section 150.

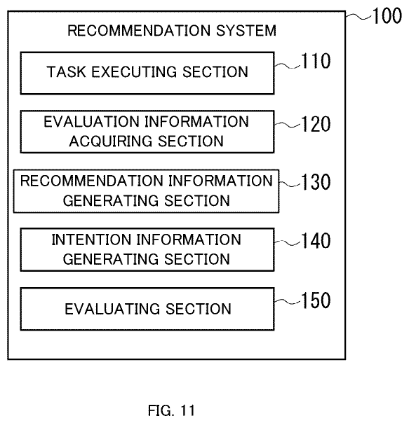

FIG. 11 is a block diagram of the recommendation system 100 according to the third embodiment. As primary constituent elements, the recommendation system 100 according to the present embodiment has the task executing section 110, the evaluation information acquiring section 120, the recommendation information generating section 130, the intention information generating section 140, and the evaluating section 150.

Using the request G11, the first response G21, and the intention information G140 as inputs, the evaluating section 150 causes the fourth language model 314 whose execution environment is different from the first language model 311 to output an evaluation score of the first response G21 generated by the first language model 311. The evaluation score is an index representing the level of generation quality. Here, the generation quality can include elements such as the accuracy, relevance, consistency, and customizability of responses as mentioned above. That is, the fourth language model 314 is configured to generate the evaluation score on the basis of the elements.

For example, the evaluation score is represented by an integer from 0 to 100. In this case, for example, it can be defined that a higher value corresponds to higher generation quality. It should be noted that the evaluation score is not limited to the definition mentioned above. The evaluation score may be a quantitative score or may be a qualitative index such as “good” or “bad.”

The recommendation information generating section 130 according to the present embodiment generates the recommendation information G22 taking into account the evaluation score. That is, the recommendation information generating section 130 according to the present embodiment inputs the evaluation score generated by the evaluating section 150 to the second language model 312, and causes the second language model 312 to generate the recommendation information G22. Thereby, the recommendation system 100 can cause the second language model 312 to generate the recommendation information G22 in a manner that facilitates comparison with the evaluation information G200 accumulated in the database 200.

The evaluating section 150 according to the present embodiment may have a function to supply the request G11 and the evaluation score corresponding to the request G11 to a database for accumulating evaluation information in a state where the request G11 and the evaluation score are associated with each other. With such a configuration, the response system 10 can enrich the evaluation information G200 by allowing users to use the response system 10.

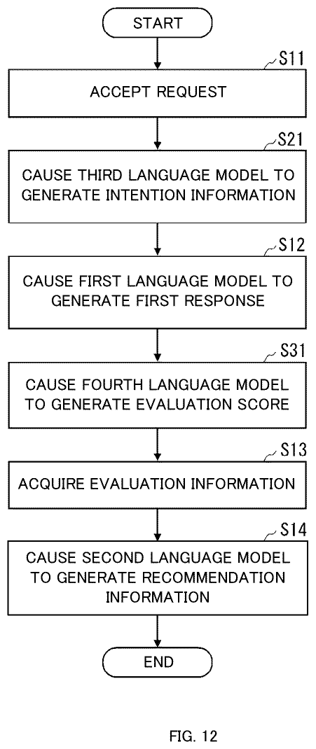

Next, a process executed by the recommendation system 100 according to the present embodiment is explained with reference to FIG. 12. FIG. 12 is a flowchart of the recommendation method according to the third embodiment. The flowchart depicted in FIG. 12 is different from the flowchart depicted in FIG. 9 in that the flowchart depicted in FIG. 12 has Step S31 after Step S12.

At Step S12 according to the present embodiment, the task executing section 110 supplies the request G11 and the intention information G140 to the first language model 311, and causes the first language model 311 to generate the first response G21. The task executing section 110 supplies, to the evaluating section 150, the request G11, and the first response G21 and the intention information G140 that the first language model 311 has been caused to generate.

At Step S31, the evaluating section 150 supplies the received request G11, first response G21, and intention information G140 to the fourth language model 314, and causes the fourth language model 314 to generate the evaluation score. The evaluating section 150 supplies, to the recommendation information generating section 130, the evaluation score that the fourth language model 314 has been caused to generate.

At Step S13, the evaluation information acquiring section 120 acquires the evaluation information G200 from the database 200. The evaluation information acquiring section 120 supplies the acquired evaluation information G200 to the recommendation information generating section 130.

At Step S14, the recommendation information generating section 130 causes the second language model 312 to generate the recommendation information G22 in cooperation with the server 300. The recommendation information generating section 130 in the present embodiment selects a recommended language model for generating a response from the plurality of language models on the basis of the request G11, the intention information G140, the first response G21, the evaluation information G200, and the evaluation score generated by the evaluating section 150. Furthermore, the second language model 312 generates the recommendation information G22 including the message to present the recommended language model to the user.

### Evaluation Information G200

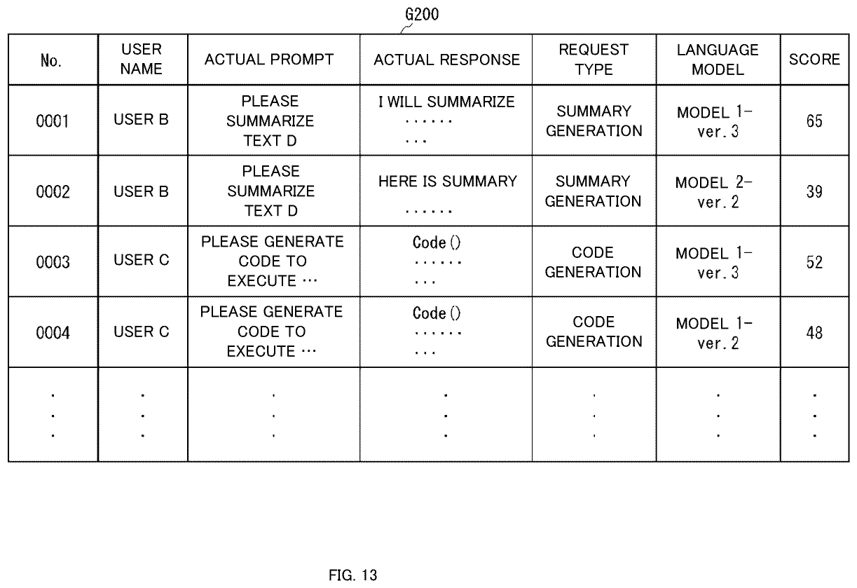

Next, the evaluation information G200 according to the present embodiment is explained with reference to FIG. 13. FIG. 13 is a second figure depicting the evaluation information G200. The evaluation information G200 depicted in FIG. 13 is different from the evaluation information G200 depicted in FIG. 5 in that the evaluation information G200 depicted in FIG. 13 includes scores. The scores are evaluations of the actual responses to the actual prompts.

For example, the evaluation information G200 includes information like the one below. The first information has content that an actual response, “I will summarize ⋅ ⋅ ⋅ ” has been obtained, and the score of the actual response is 65 in a case where the user B has transmitted a request, “Please summarize the text D,” to the language model “model 1-ver.3.” The second information has content that an actual response, “Here is the summary ⋅ ⋅ ⋅ ” has been obtained, and the score of the actual response is 39 in a case where the user B has transmitted a request, “Please summarize the text D,” to the language model “model 2-ver.2.”

The third information includes content that a code generated by the language model “model 1-ver.3” has been obtained as an actual response in a case where the user C has transmitted a request, “Please generate a code to execute ⋅ ⋅ ⋅ , ” to the language model. In addition, the third information includes content that the score of the actual response is 52.

The fourth information includes content that a code generated by the language model “model 1-ver.2” has been obtained as an actual response in a case where the user C has transmitted a request, “Please generate a code to execute ⋅ ⋅ ⋅ ,” to the language model. In addition, the third information includes content that the score of the actual response is 48.

Since the information mentioned above is included, the recommendation information generating section 130 supplies, to the second language model 312, the evaluation information G200 including the scores. Thereby, the second language model 312 can compare the evaluation information G200 and an evaluation score G150 corresponding to the first response G21. Therefore, the recommendation information generating section 130 can cause the second language model 312 to suitably generate the recommendation information including the recommended language model on the basis of objective evaluations.

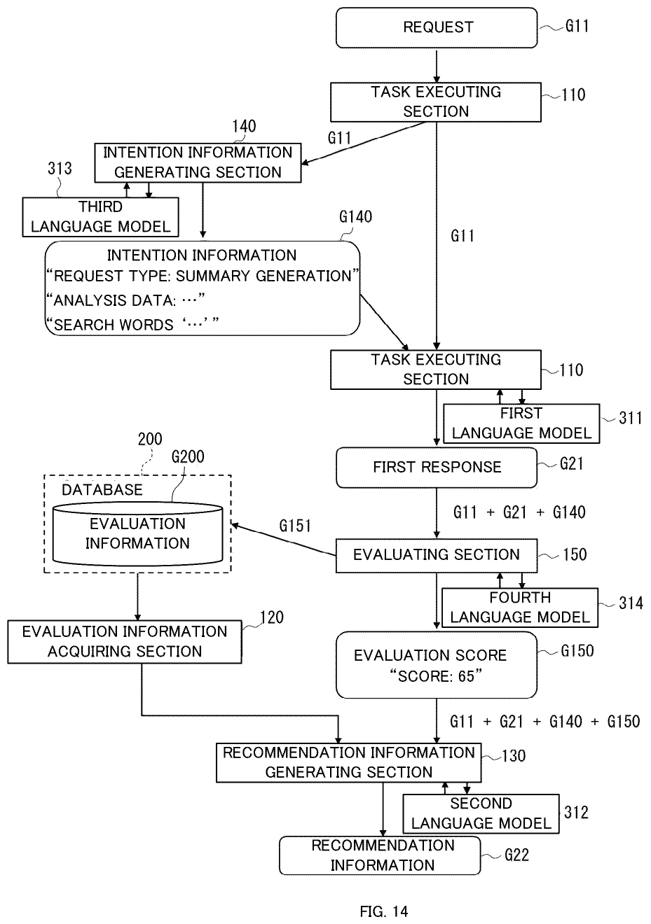

Next, the flow of the information processed by the recommendation system 100 according to the present embodiment is explained with reference to FIG. 14. FIG. 14 is a figure depicting the flow of the information in the recommendation system 100 according to the third embodiment.

The task executing section 110 according to the present embodiment causes the first language model 311 to generate the first response G21 using the intention information G140 received from the intention information generating section 140. The task executing section 110 supplies the request G11, the first response G21, and the intention information G140 to the evaluating section 150.

The evaluating section 150 supplies, to the fourth language model 314, these pieces of information received from the task executing section 110. Thereby, the evaluating section 150 causes the fourth language model 314 to generate the evaluation score G150. In the example depicted in FIG. 14, the evaluation score G150 is depicted as “Score: 65.” That is, the evaluation score G150 is 65. Upon causing the fourth language model 314 to generate the evaluation score, the evaluating section 150 supplies the request G11, the first response G21, the intention information G140, and the evaluation score G150 to the recommendation information generating section 130.

In addition, the evaluating section 150 supplies additional information G151 to the database 200. The additional information G151 is supplied to the database 200 for the purpose of being added to the evaluation information G200. That is, the additional information G151 is information corresponding to the evaluation information G200. The additional information G151 includes at least the mutually corresponding request G11, first response G21, and evaluation score G150. The additional information G151 may include part of the intention information G140.

The recommendation information generating section 130 according to the present embodiment receives the request G11, the first response G21, the intention information G140, and the evaluation score G150 from the evaluating section 150, and receives the evaluation information G200 from the evaluation information acquiring section 120. The recommendation information generating section 130 causes the fourth language model 314 to generate the recommendation information G22 taking into account the evaluation score G150.

The third embodiment has been explained thus far. The recommendation system 100 according to the present embodiment can select a more suitable recommended language model by using the evaluation score G150. In addition, the recommendation system 100 according to the present embodiment can efficiently accumulate the evaluation information G200. The recommendation system 100 can select a further suitable recommended language model using the evaluation information G200 accumulated efficiently. Therefore, the present embodiment can provide the recommendation system, the recommendation method, and the program that suitably propose an LLM that can appropriately respond to user requests.

### Fourth Embodiment

Next, a fourth embodiment is explained. The functions of the recommendation information generating section 130 in the fourth embodiment are different from the recommendation system 100 mentioned above. That is, the recommendation information generating section 130 according to the present embodiment outputs recommendation information including information about differences between the first language model 311 and the recommended language model to the user terminal 400 used by the user from whom the request G11 has been accepted.

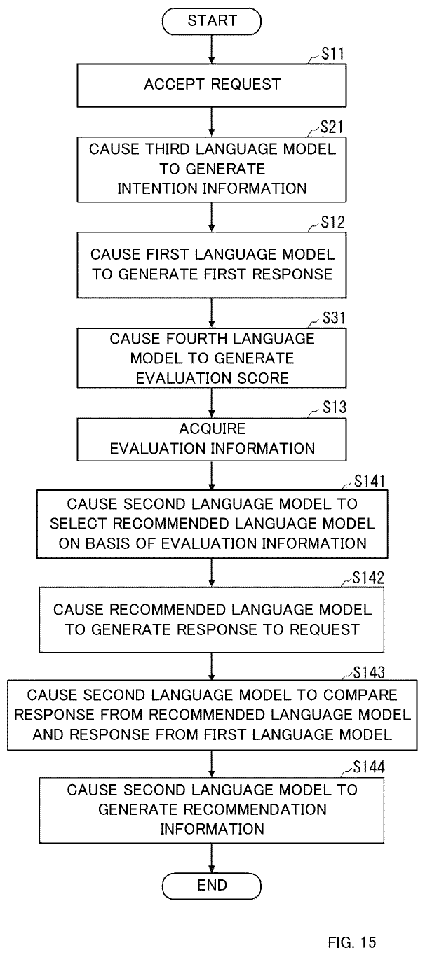

FIG. 15 is a flowchart of the recommendation method according to the fourth embodiment. The flowchart depicted in FIG. 15 is different from the flowchart depicted in FIG. 12 in that the flowchart depicted in FIG. 15 has processes from Step S141 to Step S144 instead of the process at Step S14.

At Step S141, the recommendation information generating section 130 causes the second language model 312 to select the recommended language model on the basis of the evaluation score G150.

At Step S142, the recommendation information generating section 130 supplies the request G11 to the recommended language model selected by the second language model 312, and causes the recommended language model to generate a response to the request G11.

At Step S143, the recommendation information generating section 130 causes the second language model 312 to compare the response from the recommended language model and the first response G21 from the first language model 311.

At Step S144, the recommendation information generating section 130 causes the second language model 312 to generate the recommendation information using a result of the comparison mentioned above.

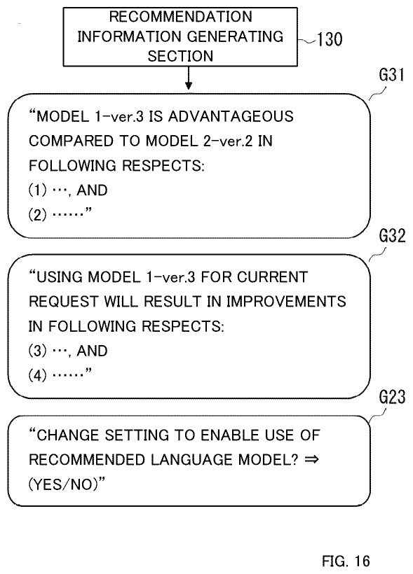

An example of the recommendation information generated by the recommendation information generating section 130 according to the fourth embodiment is explained with reference to FIG. 16. FIG. 16 is a figure depicting the recommendation information according to the fourth embodiment. The recommendation information generating section 130 depicted in FIG. 16 outputs first explanatory information G31, second explanatory information G32, and the upsell information G23 as the recommendation information.

The first explanatory information G31 includes a message comparing the recommended language model and the first language model 311, and explaining advantages of the recommended language model. The recommendation information generating section 130 causes the second language model 312 to generate the first explanatory information G31, and outputs the generated first explanatory information G31 to the user terminal 400. The first explanatory information G31 depicted in FIG. 16 includes a message, “The model 1-ver.3 is advantageous compared to the model 2-ver.2 in the following respects: (1) ⋅ ⋅ ⋅ , and (2) ⋅ ⋅ ⋅ .

By causing the recommendation information generating section 130 to output the first explanatory information G31, the recommendation system 100 can clearly indicate the advantages of the recommended language model to the user. In addition, by causing the recommendation information generating section 130 to output the first explanatory information G31, the recommendation system 100 can suitably prompt the user to use the recommended language model.

The second explanatory information G32 includes a message comparing the response from the recommended language model and the first response G21 from the first language model 311, and explaining advantages of the response from the recommended language model. The recommendation information generating section 130 causes the second language model 312 to generate the second explanatory information G32, and outputs the generated second explanatory information G32 to the user terminal 400. The second explanatory information G32 depicted in FIG. 16 includes a message, “Using the model 1-ver.3 for the current request will result in improvements in the following respects: (3) ⋅ ⋅ ⋅ , and (4) ⋅ ⋅ ⋅ .”

By causing the recommendation information generating section 130 to output the second explanatory information G32, the recommendation system 100 can clearly indicate, to the user, the specific improvements that can be achieved in a case where the recommended language model is used. In addition, by causing the recommendation information generating section 130 to output the first explanatory information G31, the recommendation system 100 can suitably prompt the user to use the recommended language model.

The recommendation information generating section 130 may output the upsell information G23 in addition to the first explanatory information G31 and the second explanatory information G32 mentioned above. By outputting the recommendation information in such a combination, the recommendation system 100 can smoothly prompt the user to use the recommended language model.

The fourth embodiment has been explained thus far. At Step S141 to Step S144 in the flowchart in FIG. 15, the recommendation information generating section 130 may supply at least part of the intention information G140 to the recommended language model. Thereby, the recommendation information generating section 130 can input a prompt similar to that for the first language model 311 to the recommended language model.

As mentioned above, according to the fourth embodiment, the recommendation system 100 can suitably prompt the user to use a language model of higher generation quality.

### Modification Example of Response System 10

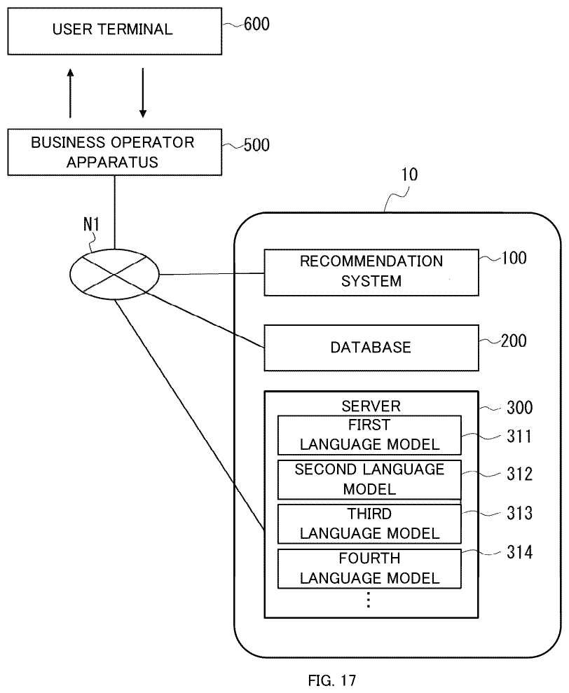

Next, a modification example of the use mode of the response system 10 is explained. FIG. 17 is a block diagram depicting a variation of the response system 10. The response system 10 depicted in FIG. 17 is different from the response system 10 depicted in FIG. 1 in that the response system 10 depicted in FIG. 17 is communicatively connected with a business operator apparatus 500 instead of the user terminal 400.

The business operator apparatus 500 is a computer, a server, a cloud service, a PaaS, SaaS, or the like for providing business-related services to a plurality of customers. The business operator apparatus 500 is communicatively connected to a plurality of customer terminals 600 by any communication means, and provides services of a business operator. Here, the services provided by the business operator to customers include response services provided by the response system 10. That is, the response system 10 provides the response services to customers of the business operator via the business operator apparatus 500, and provides the functions of the recommendation system 100 via the business operator apparatus 500. With the configuration mentioned above, the response system 10 can provide the functions of the present disclosure to various business operators.

Although the present disclosure has been explained with reference to embodiments thus far, the present disclosure is not limited to the embodiments mentioned above. Various changes that can be understood by those skilled in the art can be made to the configurations and details of the present disclosure within the scope of the present disclosure. Then, each embodiment can be combined with another embodiment as appropriate.

Each figure is merely an illustration for explaining one or more embodiments. Each figure is not associated with only one particular embodiment, but may be associated with one or more other embodiments. As those skilled in the art will be able to understand, various features or steps that are explained with reference to any one figure can be combined with features or steps depicted in one or more other figures, in order to produce embodiments which are not explicitly depicted or explained, for example. All the features or steps that are depicted in any one figure for explaining an illustrative embodiment are not necessarily essential, but some features or steps may be omitted. The order of steps described in any figure may be changed as appropriate.

1. A response system comprising:
a task executing section that accepts a request including text data from a user;
an evaluation information acquiring section that acquires, from a predetermined database, evaluation information about each of a plurality of language models; and
a recommendation information generating section that causes a language model to select a recommended language model for generating a response to the request from the plurality of language models on a basis of the request and the evaluation information, wherein
the task executing section causes the recommended language model to generate a response to the request.

2. The response system according to claim 1, further comprising an intention information generating section that causes a language model to generate, on a basis of the request, intention information for being input to the language model for a purpose of supplementing the request, wherein
the task executing section inputs at least part of the intention information to the language model, and causes the language model to generate the response.

3. The response system according to claim 2, wherein the intention information generating section generates the intention information including information about a type of the request on a basis of context of the text data.

4. The response system according to claim 2, wherein the intention information generating section includes a search engine that searches for information in a predetermined network in cooperation with the language model, and causes the language model and the search engine to generate the intention information.

5. The response system according to claim 2, further comprising an evaluating section that causes the language model to output an evaluation score of the response generated by the language model using the request, the response, and the intention information as an input, wherein
the recommendation information generating section generates recommendation information including a message to present the recommended language model to the user by taking into account the evaluation score.

6. The response system according to claim 5, wherein the evaluating section supplies the request and the evaluation score corresponding to the request to the database for accumulating the evaluation information.

7. (canceled)

8. (canceled)

9. A response method, wherein
a computer
accepts a request including text data from a user;
acquires, from a predetermined database, evaluation information about each of a plurality of language models;
causes a language model to select a recommended language model for generating a response to the request from the plurality of language models on a basis of the request and the evaluation information; and
causes the recommended language model to generate the response to the request.

10. A computer-readable storage medium that non-transitorily stores a program that causes a computer to execute a response method, the response method including:
accepting a request including text data from a user;
acquiring, from a predetermined database, evaluation information about each of a plurality of language models;
causing a language model to select a recommended language model for generating a response to the request from the plurality of language models on a basis of the request and the evaluation information; and
causing the recommended language model to generate the response to the request.
